(19) United States
(12) Patent Application Publication
(10) Pub. No.: US 2023/0072536 A1
(43) Pub. Date: Mar. 9, 2023

(54) PLATFORM SCREEN DOOR

(71) Applicant: KNORR-BREMSE RAIL SYSTEM (UK) LTD, Melksham, Wiltshire (GB)

(72) Inventor: Danny Rose, Malmesbury, Wiltshire (GB)

(21) Appl. No.: 17/794,428

(22) PCT Filed: Jan. 22, 2021
(86) PCT No.: PCT/EP2021/051525

§ 371 Date: Jul. 21, 2022

(30) Foreign Application Priority Data
Jan. 22, 2020 (GB) 2000900.7

(51) Int. Cl. B61B 1/02; E06B 3/46; E06B 5/12; F41H 5/22; F41H 5/013

(52) U.S. Cl. CPC B61B 1/02; E06B 3/4636; E06B 5/12; F41H 5/226; F41H 5/013

(57) ABSTRACT

A platform screen door system comprising a plurality of fixed panels and a plurality of sliding door panels, which sliding door panels have a proximal side to the fixed panels and a distal side remote from the fixed panel. The sliding door panels are supported by a frame, wherein the frame at distal side has a greater thickness than the frame at the proximal side.

The invention relates to the security of a platform screen door system in the event of an explosive blast in its vicinity.

Platform screen door systems or automated platform gates are well known in the railway industry as one approach of dealing with the problems inherent with open platforms. Examples of known platform screen door systems and automated platform gates are disclosed in CN208698756 and JP2012218448.

A recent concern about the introduction of platform screen door systems is that they may attract terrorist attacks as rail stations are busy public areas. The reflected pressure from an explosion in an enclosed space can obviously cause significant damage. Whilst bomb blast resistant doors are well known in high security areas, the known designs are intended to remain closed and are deliberately heavy. Many designs are also focused on protecting from a blast from one side only, whereas a platform screen door could be attacked from either side. These known designs are inherently unsuitable for a platform screen door system in which the doors need to be opened and closed every 2-3 minutes for most or all of the day.

Platform Screen Doors are moreover weight restricted. Safety requirements insist that door kinetic energy is restricted to reduce the risk of passenger injury in the event that the door strikes a passenger trying to pass through the door when it is closing, and system operating parameters require door opening times to be as short as possible. The kinetic energy of the door leaf is given by the formula:

KE=½ mv²

Increasing the mass of the door therefore requires a slower operation to maintain safe limits on the kinetic energy of the door.

The present invention seeks to provide a platform screen door with improved blast resistance without increasing mass to levels which restrict performance. Moving components are optimised for minimum mass whilst still meeting the requirements of the blast loading.

According to the invention there is provided a platform screen door system comprising a plurality of fixed panels and a plurality of sliding doors, the system further comprising a header structure which provides both structure for the system and space for control and driving mechanisms.

Preferred aspects of the invention can be found in the sub-claims.

The platform screen door of the invention advantageously provides a door system where if the blast is survivable, failure of the screens will not cause further injury to survivors. A survivable blast in the head area has been defined by Cheng J. Neurol. Sci. 2010; 294:23-28 as having the characteristics of 150 kPa peak reflected pressure in an open environment. For a trackside blast, reflected pressure levels on the doors would be reduced. The reason for the lower blast level from track side is that any explosive device delivered to track side is likely to be within the confines of a train and therefore the blast pressure will be reduced by the train body before arriving at the platform screen door panels.

An exemplary embodiment of the invention will now be described in greater detail with reference to the drawing in which:

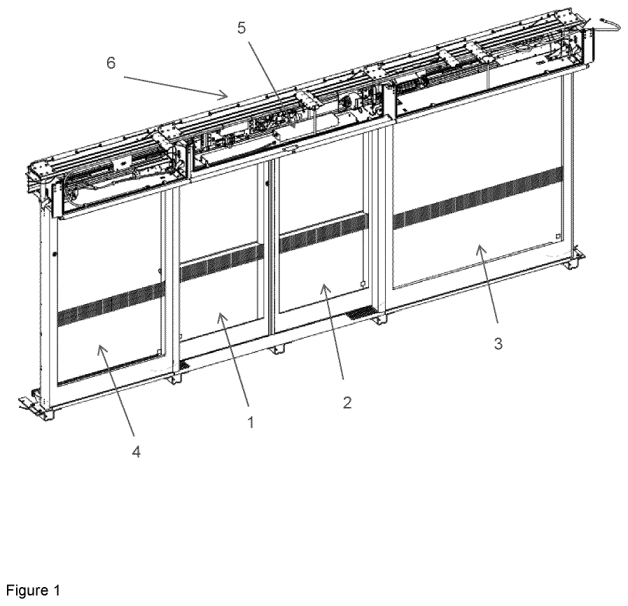

FIG. 1 shows a platform screen door system;

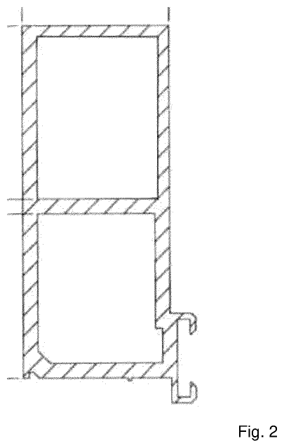

FIG. 2 shows a door frame cross-section for a sliding door.

FIG. 1 shows a platform screen door system with the doors in the closed position comprising first, 1, and second, 2, automatic sliding door (ASD) leaves, which door leaves are adapted to slide in opposite directions to one another. Each sliding door leaf 1,2 in use will slide behind a respective fixed panel 3 or Emergency Egress Door (EED), 4 which is adjacent to the sliding door in the closed position. A display panel 5 is located above the door leaves 1,2. A header structure 6 is located above the fixed panels and sliding doors, behind the display panels and glass covers, to support the structure and enclose the necessary control and drive mechanisms to open and close the doors.

The blast-resistant screen is designed to be able to withstand blast loads up to the survivable blast pressure load. Any higher blast pressure load is not deemed to be survivable, so damage to the door screen cannot make matters worse for people in the area. For loads below this survivable limit, the door system is designed such that it may deform and fail but that no components will be ejected from the system to further injure any survivors of the blast. Glass may fail but will do so at low velocity.

The hazard rating system used for this is the GSA hazard rating system, level 3b, whereby following the blast any glass fragments leave the system at low velocity and are on the ground within 10 ft of the original panel. This standard is currently GSA-TSO1-2003—US General Services Administration Standard Test Method for Glazing and Window Systems Subject to Dynamic Overpressure Loadings.

In order to achieve the above requirements, the dynamic effect of the blast load on each component is calculated, and the components sized accordingly. Yielding of a component is allowed and indeed encouraged as it helps to absorb the blast energy, but items may not break and become detached. Where conventional components are not anticipated to survive, reinforcing components are added to carry the peak loads (e.g. steel angles supporting extruded aluminium panel frames). Where items such as covers are attached with hinges and may become detached, tether cables are employed to retain the items to the screen.

The steel posts and aluminium header structure of the platform screens are designed for structural stiffness and are therefore strong enough to support the system under the blast loads. The posts may yield slightly, but they will not fail. Similarly, the fixings into header structure and platform can safely carry the reaction loads.

The three major panel components of the doors are sliding doors, fixed panels and EED/media panels (both hinged doors of similar design). The blast design for each of these components ensures:
a) The glass fails safely, eg according to GSA level 3b
b) The frames are capable of carrying the glass loads back into the structure.
c) The fixings are strong enough not to fail and allow panels to detach.

Exemplary implementations are described below:

Sliding Doors:

The door panels comprise 8.76 mm thick laminated single glazed panes that are structural silicone bonded to a perimeter aluminium box-section frame. The glass comprises two panes of 4 mm toughened glass thermally bonded to a 0.76 mm vinyl interlayer. The interlayer keeps a broken pane in one piece and stops it shattering to shrapnel. This is essential to meet the required GSA level.

Under platform side loading the door panels are “pushed away” from the steel RHS posts, which are located on either side of each pair of door panels. The panel bottom edge is restrained by a thick vertical stainless steel plate that engages with a slot in the door threshold. Under platform side loading, the panels are pushed against the slot at the bottom and the roller guide at the top. The doors panels are thus restrained at the top and bottom edges only under platform side loading. Under trackside loading the door panels are restrained at their top and bottom edges and also on the outer vertical side of each panel where it bears onto the steel box section post. The “central” vertical frames where the two door panels meet span vertically under both trackside and platform side loading. The aluminium box section frame on this inner frame section has a double box construction in which an intermediate wall member is provided within the rectangular cross section of the frame member viewed from above so that it has a figure of 8 structure as shown in FIG. 2. This may be formed by extrusion. This arrangement provides greater strength for low additional mass to support the resistance to a blast load.

Fixed Panels:

The larger fixed panels comprise 10.76 mm thick laminated single glazed panes that are structural silicone bonded to a perimeter aluminium box-section frame. This frame is provided with a continuous support on its vertical edges by means of mild steel angles that are bolted to the sides of steel posts 12 on either side of each fixed panel.

The lower horizontal frames of the large fixed panels 3,4 are connected to the steel posts at each end and to the steel threshold structure at mid span and a short distance along the span from each end. The upper horizontal elements of all large fixed panels are provided with steel angle sections bolted to the trackside face of the aluminium box section to stiffen and strengthen them.

EED and Media Panels:

These are hinged doors of similar construction to the above. Steel angles on the posts support the vertical frame members when load is from platform side. Under trackside loading, as the door is openable, the load will push the door away from these angle supports and the only means of restraint are the locking bolts and hinge pin pivots at the top and bottom corners of the panel. Under trackside loading the EED panel is strong enough to effectively span vertically between these points of restraint

1. A platform screen door system comprising a plurality of fixed panels and a plurality of sliding door panels, which sliding door panels have a proximal side to the fixed panels and a distal side remote from the fixed panel, the system further comprising a header structure for receiving at least part of a door driving means, wherein the sliding door panels are supported by a frame, wherein the frame at distal side has a greater thickness than the frame at the proximal side.

2. The platform screen door system according to claim 1, wherein the frame has a double box structure.

3. The platform screen door system according to claim 1, wherein the panels are configured to yield but not fail in response to a blast pressure.

4. The platform screen door system according to claim 1, wherein at least one door panel and/or at least one fixed panel is provided with a glass pane, which glass pane is bonded to a perimeter frame of the panel and the panel is compatible with GSA hazard rating system, level 3b, when subjected to a survivable blast load.

5. The platform screen door according to claim 1, wherein at least one panel is tethered by a cable to a further component of the platform screen door system.

6. The platform screen door according to claim 1, wherein the door panels are restrained at their respective top and bottom edges.

7. The platform screen door according to claim 1, wherein at least one panel frame is provided with an angle, which angle is connected to the frame and to a post, which post is mounted on the platform.
